(19) United States
(12) Patent Application Publication
(10) Pub. No.: US 2008/0104445 A1
(43) Pub. Date: May 1, 2008

(54) RAID ARRAY

(75) Inventor: Srikanth ANANTHAMURTHY, Bangalore Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/932,743

(22) Filed: Oct. 31, 2007

(30) Foreign Application Priority Data
Oct. 31, 2006 (IN) 2002/CHE/2006

(51) Int. Cl. G06F 11/07; G06F 12/00

(52) U.S. Cl. 714/6; 711/114; 711/E12.001; 714/E11.021

(57) ABSTRACT

A method of providing a RAID array, comprising providing an array of disks (202a-202f), creating an array layout (200) comprising a plurality of blocks (D1-D26, P1-P10) on each of the disks (202a-202f) and a plurality of disk stripes (204a-204j) that can be depicted in the layout (200) with the stripes parallel to one another and diagonal to the disks, and assigning data blocks (D1-D26) and parity blocks(P1-P10) in the array layout (200) with at least one parity block per disk stripe.

### RELATED APPLICATIONS

The present application is based on and corresponds to Indian Application Number 2002/CHE/2006 filed Oct. 31, 2006, the disclosure of which is hereby incorporated by reference herein in its entirety.

### BACKGROUND OF THE INVENTION

RAID is a popular technology used to provide data availability and redundancy in storage disk arrays. There are a number of RAID levels defined and used in the data storage industry. The primary factors that influence the choice of a RAID level are data availability, performance and capacity.

RAID5, for example, is one of the most popular RAID levels that are used in disk arrays. RAID5 maintains a parity disk for each set of disks, and stripes data and parity across the set of available disks. FIG. 1 is a schematic view of the array layout 100 of a background art RAID5 disk array, comprising disk stripes 102a,b,c,d,e,f. Each disk stripe contains data blocks (D1, D2, . . . , D30) and one parity block (P1, P2, . . . , P6). A parity block holds the parity of all the (five) data blocks in its respective disk stripe. Thus, for example, P1=D1+D2+D3+D4+D5, and P6=D26+D27+D28+D29+D30 (where ‘+’ denotes an XOR operation).

If a drive fails in the RAID5 array, the failed data can be accessed by reading all the other data and parity drives. By this mechanism, RAID5 can sustain one disk failure and still provide access to all the user data. However, RAID5 has two main disadvantages. Firstly, when a write comes to an existing data block in the array stripe, both the data block and the parity blocks must be read and written back, so four I/Os are required for one write operation. This creates a performance bottleneck, especially in enterprise level arrays. Secondly, when a disk fails, all the remaining drives have to be read to rebuild the failed data and re-create it on the spare drive. This recovery operation is termed “rebuilding” and takes some time to complete and, while rebuilding occurs, there is the risk of data loss if another disk fails.

### BRIEF DESCRIPTION OF THE DRAWING

In order that the invention may be more clearly ascertained, embodiments will now be described, by way of example, with reference to the accompanying drawing, in which:

FIG. 1 is a schematic view of the array layout of a RAID5 disk array according to the background art.

FIG. 2 is a schematic view of a disk array layout according to an embodiment of the present invention.

FIG. 3 is a schematic view of a disk array layout comprising three storage units according to an embodiment of the present invention.

FIG. 4 is a flow diagram of a method of providing a RAID array according to an embodiment of the present invention.

FIG. 5 is a schematic view of the disk array layout of the embodiment of the FIG. 2 with a spare disk, following disk failure.

FIG. 6 is a flow diagram of a method of reconstructing lost data according to an embodiment of the present invention.

FIG. 7 is schematic view of the disk array layout of the embodiment of the FIG. 2, with data blocks divided into two groups to improve data storage.

FIG. 8 is a schematic view of a disk array layout according to another embodiment of the present invention.

FIG. 9 is a schematic view of a disk array layout according to yet another embodiment of the present invention.

### DETAILED DESCRIPTION OF THE EMBODIMENTS

There will be described a method of providing a RAID array.

In one embodiment the method comprises providing an array of disks, creating an array layout comprising a plurality of blocks on each of the disks and a plurality of disk stripes that can be depicted in the layout with the stripes parallel to one another and diagonal to the disks, and assigning data blocks and parity blocks in the array layout with at least one parity block per disk stripe.

There will also be described a method of storing data, a method for reconstructing the data of a failed or otherwise inaccessible disk of a RAID array of disks, and a RAID disk array.

FIG. 2 is a schematic view of the layout 200 of a RAID disk array according to an embodiment of the present invention, comprising six disks 202a,b,c,d,e,f. The array layout 200 includes data blocks (D1, D2, . . . , D26) and parity blocks P1, P2, . . . , P10. The first disk 202a has six data blocks, each of second to fifth disks 202b,c,d,e contains five data blocks and one parity block, while last disk 202f contains six parity blocks.

Each parity block P1 to P10 holds the parity of the data blocks along the diagonals (running from lower right to upper left in the figure) of the disk array layout 200.

Thus:

P1=D26 (P1 thus reflects the data block on diagonally opposite corner of array layout 200)

P2=D5

P3=D4+D10

P4=D3+D9+D15

P5=D2+D8+D14+D20

P6=D1+D7+D13+D19+D25

P7=D6+D12+D18+D24

P8=D11+D17+D23

P9=D16+D22

P10=D21

where ‘+’ denotes an XOR operation.

This approach therefore divides the available blocks into ten diagonal disk stripes 204a,b,c,d,e,f,g,h,i,j with varying RAID levels:
disk stripes 204a,b,j (i.e. {P11, D26}, {P2, D5} and {P10, D21}) are in RAID1;
disk stripes 204c,i (i.e. {P3, D4, D10} and {P9, D16, D22}) are in ‘Split Parity RAID5’;
disk stripes 204d,h (i.e. {P4, D3, D9, D15} and {P8, D11, D17, D23}) are in RAID5 with 4 disks;
disk stripes 204e,g (i.e. {P5, D2, D8, D14, D20} and {P7, D6, D12, D18, D24}) are in are RAID5 with 5 disks; and
disk stripe 204f (i.e. {P6, D1, D7, D13, D19, D25}) is in RAID5 with 6 disks.

Array layout 200 constitutes a basic block of storage (or ‘storage unit’) according to this embodiment, comprising 6×6 blocks. This storage unit comprises—in this embodiment—a square matrix, which can however be of different sizes. (In other embodiments a storage unit may not be square.) In a disk array, each stripe chunk has one or more storage units.

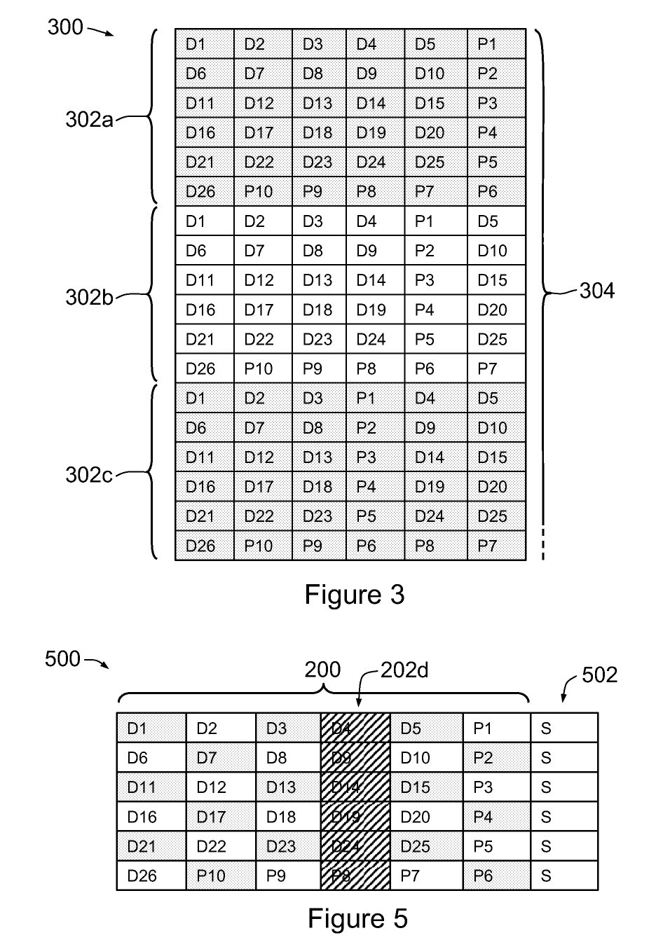

The parity blocks inside a storage unit are not distributed as in RAID5. However the parity blocks can be shifted to another disk in the next storage unit. For example, if a disk array has stripe chunks each with 20 storage units, then in the first storage unit, the sixth disk may hold the parity blocks, in the second storage unit, the fifth disk may hold the parity blocks, and so on. However, the parity associations in all the blocks will be the same. Thus, FIG. 3 depicts at 300 three storage units 302a, 302b, 302c belonging to a single stripe chunk 304 (of three or more storage units).

A logical unit (LU) can be allocated many such storage units. Also a LU can be allocated a mix of RAID1 storage units, RAID5 storage units and diagonal stripe storage units of the present embodiment. The amount of mixing depends on what RAID1 to RAID5 ratio the data residing in the LU demands. A user can specify a particular mix, or a system might allocate a predetermined mixture of all these stripes.

Inside a diagonal stripe storage unit, data can be moved from RAID1 to RAID5-3, RAID5-4, etc, depending on which units are most used. Therefore, unlike AutoRAID where data belong to any LU can be moved from RAID1 to RAIDS, this embodiment restricts data movement across RAID levels within a LU.

The method of this embodiment should improve the write performance of the disk array when compared with conventional RAID5 in many circumstances. In conventional RAID5, small writes that come to updated data blocks perform poorly. They employ the read-modify-write (RMW) style where in both the data and parity blocks are read, modified and updated. Each RMW write requires 4 I/Os and 2 parity calculations. According to this embodiment, not all data blocks have to perform RMW writes. The data blocks in RAID5 stripes have to perform RMW writes. The data blocks in Split Parity RAID5 stripes require 3 I/Os and 1 parity calculation for each RMW. The data blocks in the RAID1 stripes require 2 writes for each incoming write.

The below table indicates the number of I/Os and parity calculations that are required to perform random I/Os (which require RMW) on both a conventional RAID5 layout and on the layout of the present embodiment, with data blocks D1 to D26 (as employed in array layout 200 of FIG. 2). The number of random writes is assumed to change each data block individually, that is, 26 random I/Os are assumed to hit each data block.

| | Random Writes | Reads |
|---|---|---|
| With RAID5 | 104 I/Os, 52 parity | 26 I/Os |
| | calculations | |
| With this | 94 I/Os, 42 parity | 26 I/Os |
| embodiment | calculations | |
| Benefit (this | 10 I/Os, 10 parity | 0 |
| embodiment) | calculations | |

The number of I/Os required for reads are the same. However, for the data blocks that are in RAID1 mode, reads can happen in parallel on the original and mirror blocks and hence there can be some benefit according to this embodiment.

The performance of sequential writes is difficult to predict as the performance depends on the span of the sequential writes. Generally for large sequential writes, RAID5 is expected to perform better than the method of this embodiment.

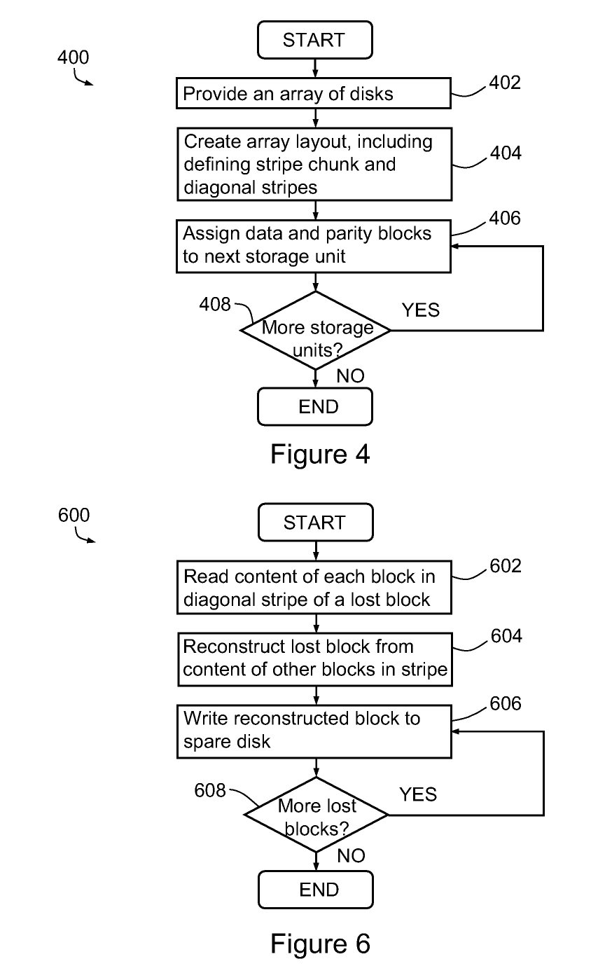

The present embodiment also provides a method of providing a RAID array, for use when storing data in a RAID array, which is summarized in flow diagram 400 of FIG. 4. At step 402, an array of disks is provided (such as the six disk array reflected in the layout of FIG. 2). At step 404, the array layout is created, including defining a stripe chunk, including one or more storage units within the stripe chunk, and diagonal disk stripes. Array layout 200 of FIG. 2, for example, reflects an array comprising a stripe chunk of one, 6×6 storage unit. It should be understood that the stripes are described as ‘diagonal’ because they can be depicted—such as in FIG. 2—to run parallel and diagonally relative to the disks (which run vertically in FIG. 2). The term ‘diagonal’ is not intended to suggest that the stripes are physically diagonal or that they could not be depicted other than diagonally. It should be understood that a diagonal disk stripe, though depicted as traversing an array layout more than once, can still constitute a single diagonal disk stripe. Hence, diagonally opposite corners of an array layout can constitute a single diagonal disk stripe (see, for example, {P1, D26} in array layout 200), as can disk stripe {P2, D21, D4} of non-square array layout 800 of FIG. 8 (described below).

At step 406, data and parity blocks are assigned in the next storage unit (which may be the first or indeed only storage unit). In practice this step may be performed simultaneously with or as a part of step 404. This step comprises selecting—in each respective storage unit—a block to act as parity block and the remainder of the blocks to act as data blocks. In this particular embodiment, this is done by selecting one disk of each respective storage unit, all of whose blocks—in the respective storage unit—are to act as parity blocks, though the disk selected for this purpose may differ from one storage unit to another.

This assignment also includes specifying one block of all but one of the other disks of the respective storage unit to act as a parity block. If the storage unit is one of a plurality of storage units in the stripe chunk, this step includes selecting a different disk to provide parity blocks exclusively from that selected for that purpose in the previous storage unit, but adjacent thereto (cf. FIG. 3).

At step 408, it is determined if the stripe chunk includes more storage units. If so, processing returns to step 406. Otherwise, processing ends.

The method of this embodiment is expected to perform better than conventional RAID5 in data reconstruction operation as well. FIG. 5 is a schematic view 500 of the array layout 200 of FIG. 2 with a spare disk 502 and a failed fourth disk 202d. The present embodiment provides a method for data reconstruction that involves reconstructing he lost data from the blocks in the respective diagonal stripes (other, of course, the blocks on the failed disk). In this example, therefore, the lost data can be reconstructed to the spare disk S as follows:

| LOST | | REQUIRED | REQUIRED |
|---|---|---|---|
| BLOCK | RECONSTRUCTED FROM | READS | WRITES |
| D4 = | P3 + D10 | 2 | 1 |
| D9 = | P4 + D3 + D15 | 3 | 1 |
| D14 = | P5 + D2 + D8 + D20 | 4 | 1 |
| D19 = | P6 + D1 + D7 + D13 + D25 | 5 | 1 |
| D24 = | P7 + D6 + D12 + D18 | 4 | 1 |
| P8 = | D11 + D17 + D23 | 3 | 1 |

Thus, 21 reads and 6 writes are required. By comparison, 30 reads and 6 writes would be required to perform the same recovery in normal RAID5.

This method of data reconstruction is summarized in flow diagram 600 of FIG. 6. At step 602, following disk failure, the content of each of the blocks in the diagonal disk stripe of a lost block of the failed disk is read. At step 604, that lost block (whether a data block or a parity block) is reconstructed from the content of the other blocks read thus. At step 606, the reconstructed block is written to the spare disk in the block location of the spare corresponding to the original location in the failed disk of the block now reconstructed.

At step 608, it is determined if there remains any other lost block in the failed disk. If so, processing returns to step 602. If not, processing ends.

If the disk that fails is towards the periphery of the array layout, fewer I/Os and parity calculations will be required. For example, if first disk 202a fails, then the following operations will be required:
D1=D7+D13+D19+D25+P6
D6=D12+D18+D24+P7
D11=D17+D23+P8
D16=D22+P9
D21=P10
D26=P1

This requires 16 reads, 4 parity calculations and 5 writes, or 21 I/Os and 4 parity calculations.

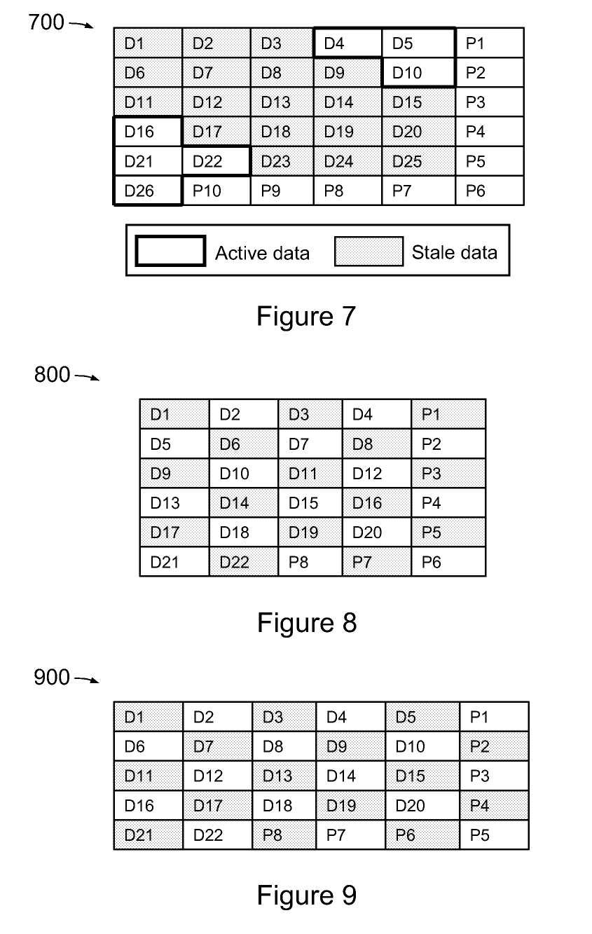

The method of this embodiment provides scope for improved data storage. FIG. 7 depicts—at 700—array layout 200 of FIG. 2 with data blocks divided into two groups. The data blocks that are most used (i.e. contain ‘active’ data) are stored in the corners of the array layout 200 such that they reside in RAID1 or Split Parity RAIDS level. In this example, these are data blocks D4, D5, D10, D16, D21, D22 and D26. The other data blocks, being less used (i.e. containing ‘stale’ data), are stored in RAID5 mode.

Although all the exemplary storage units described above are square (e.g. 6×6), in other embodiments this need not be so (though it may mean that there not be any RAID1 type storage). For example, FIG. 8 depicts an array layout 800 comprising a 5×6 storage unit. That is, the layout reflects an array of five disks, each contributing six blocks to the storage unit. The disk stripes are thus:
{P1, D17, 22}, {P2, D21, D4}, {P3, D3, D8} and {P8, D13, D18} in ‘Split Parity RAID5’;
{P4, D2, D7, D12} and {P7, D9, D14, D19} in RAID5 with 4 disks; and
{P5, D1, D6, D1, D16} and {P6, D5, D10, D15, D20} in RAID5 with 5 disks.

FIG. 9 depicts an array layout 900 comprising a 6×5 storage unit; this layout reflects an array of six disks, each contributing five blocks to the storage unit. The disk stripes are thus:
{P1, D16, 22}, {P2, D21, D5}, {P3, D4, D10} and {P8, D11, D17} in ‘Split Parity RAID5’;
{P4, D3, D9, D15} and {P7, D6, D12, D18} in RAID5 with 4 disks; and
{P5, D2, D8, D14, D20} and {P6, D1, D7, D13, D19} in RAID5 with 5 disks.

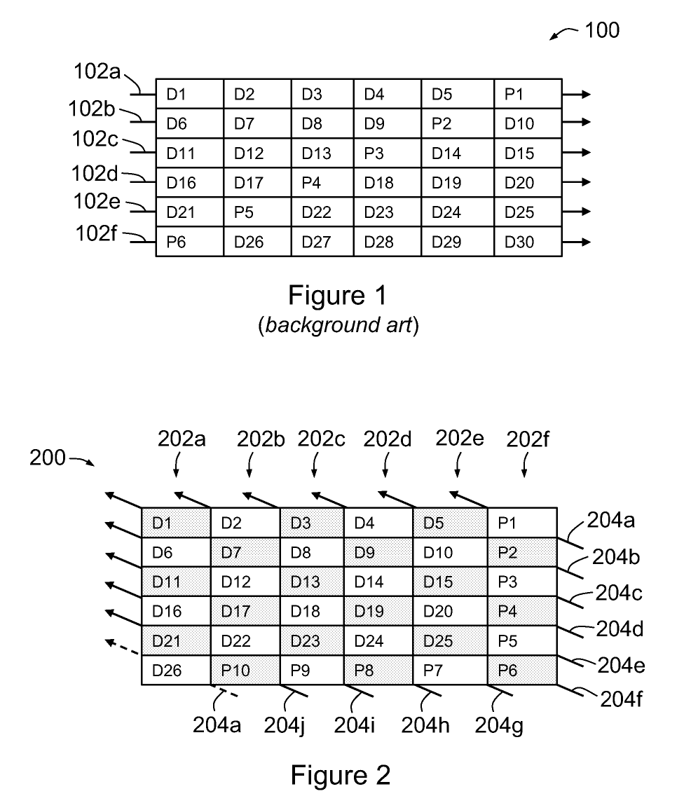

The method and array layout of the above-described embodiments may not be the most suitable in all applications. For example, the usable capacity of the array layout of FIG. 2 is less than that of RAID5. According to RAID5, 30 data blocks can be accommodated in a 6×6 storage unit (as shown in FIG. 1), whereas array layout 200 of FIG. 2 has 26 data blocks.

Furthermore, this method requires a more complex RAID management algorithm to manage the three different RAID levels and to keep track of the diagonal striping.

In some embodiments the necessary software for controlling a computer system to perform the method 400 of FIG. 4 or the method 600 of FIG. 6 is provided on a data storage medium. It will be understood that, in this embodiment, the particular type of data storage medium may be selected according to need or other requirements. For example, instead of a CD-ROM the data storage medium could be in the form of a magnetic medium, but any data storage medium will suffice.

The foregoing description of the exemplary embodiments is provided to enable any person skilled in the art to make or use the present invention. While the invention has been described with respect to particular illustrated embodiments, various modifications to these embodiments will readily be apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is to be accorded the widest scope consistent with the principles and novel features disclosed herein.

1. A method of providing a RAID array, comprising the steps of:
creating an array layout comprising a plurality of blocks on each of a plurality of disks and a plurality of disk stripes that can be depicted in said layout with said stripes parallel to one another and diagonal to said disks; and
assigning data blocks and parity blocks in said array layout with at least one parity block per disk stripe.

2. The method as claimed in claim 1, wherein blocks of one of said disks serve exclusively as parity blocks.

3. The method as claimed in claim 1, wherein said array layout is square.

4. The method as claimed in claim 1, wherein said stripes have a plurality of RAID levels.

5. The method as claimed in claim 1, including creating an array layout having a plurality of storage units, employing the blocks of one of said disks as parity blocks exclusively in a one of said storage units and employing the blocks of another of said disks as parity blocks exclusively in another of said storage units.

6. A method of storing data, comprising the steps of:
creating an array layout comprising a plurality of blocks on each of a plurality of disks and a plurality of disk stripes that can be depicted in said layout with said stripes parallel to one another and diagonal to said disks;
assigning data blocks and parity blocks in said array layout; and
storing said data in said array.

7. The method as claimed in claim 6, including storing more frequently used or active data inside an individual storage unit or logical unit to a RAID1 and RAID5-3 level.

8. A method for reconstructing the data of a failed or otherwise inaccessible disk of a RAID array of disks having an array layout comprising disk stripes depictable parallel to one another and diagonal to said disks, the method comprising:
reading the content of each block of said failed or otherwise inaccessible disk from all other blocks in the respective disk stripe to which each respective block belongs; and
reconstructing each block from the content of the read blocks.

9. The method as claimed in claim 8, further comprising writing the reconstructed blocks to another disk.

10. A RAID disk array comprising an array of disks each with a plurality of blocks, wherein said array of disks are arranged to cooperate as a plurality of disk stripes that can be depicted as an array layout with said stripes parallel to one another and diagonal to said disks, with at least one parity block per disk stripe.
